(19) United States
(12) Patent Application Publication
(10) Pub. No.: US 2015/0367327 A1
(43) Pub. Date: Dec. 24, 2015

(54) Catalytic Zinc Oxide

(71) Applicant: METALLIC WASTE SOLUTIONS PTY LTD, Victoria (AU)

(72) Inventor: Raymond Shaw, Princess Hill (AU)

(73) Assignee: Metallic Waste Solutions PTY LTD, Victoria (AU)

(21) Appl. No.: 14/767,955

(22) PCT Filed: Feb. 14, 2014
(86) PCT No.: PCT/AU2014/000124

§ 371 Date: Aug. 14, 2015

(30) Foreign Application Priority Data
Feb. 14, 2013 (AU) 2013900523

(51) Int. Cl. B01J 23/06; C01G 9/02; B01J 35/10; B01J 35/02; B01J 37/08; B01J 37/06

(52) U.S. Cl. CPC B01J 23/06; B01J 37/08; B01J 37/06; B01J 35/1009; B01J 35/023; C01G 9/02

(57) ABSTRACT

A method of producing a controlled reactivity zinc oxide including the step of: heat treatment a zinc oxide powder or precursor thereof at a temperature of at least 450° C.

### CROSS-REFERENCE

This application claims priority from Australian Application No. 2013900523 filed on 14 Feb. 2013, the contents of which are to be taken as incorporated herein by this reference.

### FIELD OF THE INVENTION

The present invention generally relates to a catalytic zinc oxide, and in particular to a high reactivity low surface area catalytic zinc oxide with improved handling properties. The invention is particularly applicable as an improved catalytic ZnO powder for rubber vulcanization and it will be convenient to hereinafter disclose the invention in relation to that exemplary application. However, it is to be appreciated that the invention is not limited to that application and could be used in other applicable catalytic or activation applications and/or where handling the zinc oxide causes difficulties especially due to dustiness.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Almost all of the current zinc oxide available is produced using the French process, in which zinc metal is vaporised and that Zn vapour is reacted with oxygen to give very fine zinc oxide particulates, typically of the size 0.2 to 0.5 μm. Zinc oxide powder produced in this manner has high surface area commensurate with the fine particle size and typically ranges from 2 to 9 m²/g. The higher surface area products are produced by manipulating the zinc vaporization rate and oxidation. Vaporisation and vapour reaction typically in an atmosphere where the gas contains a mixture of air and products from the use of carbonaceous fuels and/or reductants.

One of the most important and largest uses of zinc oxide in industry is as an activating catalyst for vulcanisation of rubber. Zinc oxide is used in conjunction with stearic acid to activate sulfur for crosslinking of rubber.

Furthermore, automobile products are one of the most significant market for rubber. In addition to tyres, rubber is used in belts, hoses, oil seals, trim and mountings. The automobile industry dictate that these products are produced to a high standard of quality, which in turn imposes on raw material suppliers of those products, including zinc oxide used for rubber manufacture.

French process zinc oxide is currently preferred for rubber uses because the purity and physical characteristics of this powder can be controlled within close limits. The important properties of zinc oxide that are relevant to rubber are:
Reactivity—conventionally measured as a function of fine powder particle size or as the inverse measurement, a high surface area;
Low oversize—to prevent point defects in the compound;
High purity—some elements, for example manganese, are detrimental to rubber curing at very low levels, and other compounds such as some soluble salts can reduce the resistance of rubber.

The surface area is most important where the ZnO is used as part of chemical reactions such as in the vulcanization of rubber. Conventional studies have found a relationship between the ZnO surface area and the reactivity with the high surface area products giving faster vulcanization rates for ZnO produced by the French Process.

Niche high surface area ZnO products have been previously produced, but are not widely used. U.S. Pat. No. 7,939,037 (Clais et al) discloses a methodology for using calcination and subsequent wet milling to prepare improved controlled particle size and surface area materials with nodular shape with surface areas of either around 40 m²/g or from 5 to 15 m²/g depending on their target use.

These products are all based on the perceived requirement that a high surface area of 5 to 15 m²/g is preferred for use in rubber formulations to give sufficiently high curing rates and product properties.

It would therefore be desirable to provide an alternative and/or improved catalytic zinc oxide suitable for applications such as rubber activation or the like.

### SUMMARY OF THE INVENTION

A first aspect of the present invention provides a method of producing a catalytic zinc oxide, the method including the step of:
roasting a zinc oxide powder or suitable precursor thereof at a temperature of at least 450° C.

The present invention therefore provides a heat treatment process which produces an improved catalytic zinc oxide. Control of the temperature and other parameters of the heat treatment enable a zinc oxide to be produced having a controlled surface area and surface activity. These properties are optimised for applications such as rubber vulcanization where these properties are critical.

A large variety of zinc oxide materials and precursor materials can be heat treated according to the present invention in order to produce catalytic zinc oxide. For example zinc oxide produced from the French Process, or a hydrometallurgical ZnO process such as the Metsol Process could be used as a feed material. Furthermore, suitable zinc oxide precursor include (but are not limited to) at least one of zinc hydroxide, or zinc hydroxy chloride.

The roasting step can be conducted in a variety of conditions and environments. In a preferred embodiment, the roasting step is conducted in an oxygen containing atmosphere, preferably air. Preferably, the atmosphere is substantially free of impurities, preferably comprising a clean or filtered atmosphere, for example clean or filtered air. The roasting step can also be conducted at a selected pressure or pressures. However, in a preferred embodiment, the roasting step is conducted at or near atmospheric pressure.

The selected temperature of the roasting step is dependent on a number of factors, including the desired surface area, crystal morphology, process origin of the zinc oxide (i.e. French process, hydrometallurgical, for example Metsol process or the like). In most embodiments, the roasting step is conducted at a temperature of between 45° C. and 1000° C. In most cases, a higher temperature leads to a lower surface area, and better crystal morphology. The roasting step is therefore preferably conducted at a temperature of at least 500° C., more preferably at least 650° C., more preferably between 600° C. and 900° C., and yet more preferably greater than 800° C. In some embodiments, the roasting temperature is about 850° C.

The roasting step may comprise one or more roasting stages to convert the zinc oxide or precursor thereof to catalytic zinc oxide. In some embodiments, the roasting step comprises at least two roasting stages. For example, in some embodiments the roasting stages may include:
at least a first roasting stage in which the zinc oxide powder or precursor is roasted to a temperature of between 200° C. and 500° C.; and
at least a second roasting stage in which the zinc oxide powder or precursor is roasted to a temperature of greater than 500° C.

The roasting time is generally dependent on the quantity of ZnO being roasted. It should also be appreciated that roasting time is also equipment dependent. Therefore, in some embodiments, the zinc oxide powder or precursor is roasted in the roasting step for at least 0.1 hour, preferably at least 1 hour, and more preferably between 1 and 20 hours, yet more preferably between 2 and 10 hours, and yet more preferably between 2 and 6 hours. However, it should be appreciated that the roasting time may differ, even significantly differ for different quantity of ZnO and/or types and configurations of roasting equipment.

The method of the present invention may include one or more pre-treatment steps prior to the roasting step. In some embodiments, the method includes the step prior to the roasting step of:
washing the zinc oxide powder or precursor in a hydrolysis solution comprising at least one of water or a dilute ammonia solution.

The dilute ammonia solution is preferably an aqueous solution containing 3 g/L to 15 g/L ammonia.

The hydrolysis solution is preferably hot, and is therefore preferably heated to a temperature of at least 90° C., and preferably between 90° C. and 200° C.

A second aspect of the present invention provides, a process for producing catalytic zinc oxide from a zinc containing material including the steps of:
leaching the zinc containing material with an alkaline lixiviant comprising an aqueous mixture of NH₃ and NH₄Cl, or ionic equivalent, having a NH₄Cl concentration of between about 10 g/L and about 150 g/L H₂O and a NH₃ concentration of between 20 g/L H₂O and 250 g/L H₂O, to produce a zinc containing leachate and a solid residue;
stripping ammonia from the leachate to produce a stripped liquor which includes a zinc containing precipitate, the stripped liquor having a NH₃ concentration of between 7 and 30 g/L H₂O;
separating the zinc containing precipitate from the stripped liquor; and
roasting the zinc containing precipitate to a temperature of at least 450° C. to convert the zinc containing precipitate into zinc oxide.

The second aspect therefore provides a modified Metsol process for producing zinc oxide from a zinc containing material. In this modified process (catalytic ZnO Metsol process), the stripped zinc containing precipitate is subjected to a roasting step in accordance with the first aspect of the present invention to produce the desired catalytic properties (crystal morphology, surface area, porosity, impurities, chloride) in the produced zinc oxide.

It is to be understood that the “zinc containing material” used in the process of the present invention (catalytic ZnO Metsol process) can be any material including material containing zinc species are such as:
i. Materials containing zinc oxide and other metal oxides such as galvanisers' ash, EAF dust, zinc containing ores selected from oxidised ores, sulphide ores, calcined zinc carbonate ores, zinc silicate ores or the like, mineral processing residues, water treatment precipitates, contaminated soils, waste stock-piles, or solid waste streams.
ii. Materials containing mixed-metal oxides including zinc where a “mixed-metal” oxide is a compound composed of zinc oxygen and at least one other metal (e.g. zinc ferrite, or zinc ferrate, such as EAF dust, oxidised ores or the like);
iii. Materials arising from furnace treatment of zinc containing materials such as arise from treating EAF Dust in Waelz kilns or other furnaces;
iv. Materials obtained from treating mixed metal oxides such as zinc ferrite in furnaces to disrupt the structure and improve the leaching characteristics; and
v. Mineral processing residues.

In preferred embodiments, the zinc containing material comprises at least one of an electric arc furnace dust, or a zinc containing ore selected from oxidised ores, sulphide ores, calcined zinc carbonate ores, or zinc silicate ores.

Similar to the first aspect of the present invention, the roasting step can be conducted in a variety of conditions and environments. In a preferred embodiment, the roasting step is conducted in an oxygen containing atmosphere, preferably air. Preferably, the atmosphere is substantially free of impurities, preferably comprising a clean or filtered atmosphere, for example clean or filtered air. The roasting step can also be conducted at a selected pressure or pressures. However, in a preferred embodiment, the roasting step is conducted at or near atmospheric pressure.

The selected temperature of the roasting step is dependent on a number of factors, including the desired surface area, and crystal morphology. In most embodiments, the roasting step is conducted at a temperature of between 450° C. and 1000° C. In most cases, a higher temperature leads to a lower surface area, and better crystal morphology. The roasting step is therefore preferably conducted at a temperature of at least 500° C., more preferably at least 650° C., more preferably between 600° C. and 900° C., and yet more preferably greater than 800° C. In some embodiments, the roasting temperature is about 850° C.

The roasting step may comprise one or more roasting stages to convert the zinc containing precipitate to catalytic zinc oxide. In some embodiments, the roasting step comprises at least two roasting stages. For example, in some embodiments the roasting stages may include:
at least a first roasting stage in which the zinc containing precipitate is roasted to a temperature of between 200° C. and 500° C.; and
at least a second roasting stage in which the zinc containing precipitate is roasted to a temperature of greater than 500° C.

The roasting time is generally dependent on the quantity of ZnO being roasted. It should also be appreciated that roasting time is also equipment dependent. Therefore, in some embodiments the zinc oxide powder or precursor is roasted in the roasting step for at least 0.1 hour, preferably at least 1 hour, and more preferably between 1 and 20 hours, yet more preferably between 2 and 10 hours, and yet more preferably between 2 and 6 hours. However, it should be appreciated that the roasting time may differ, even significantly differ for different quantity of ZnO and/or types and configurations of roasting equipment.

The method of the present invention may include one or more pre-treatment steps prior to the roasting step. In some embodiments, the method includes the step prior to the roasting step of:
washing the zinc containing precipitate in a hydrolysis solution comprising at least one of water, dilute ammonia solution.

The dilute ammonia solution is preferably an aqueous solution containing 3 g/L to 15 g/L ammonia.

The hydrolysis solution is preferably hot, and is therefore preferably heated to a temperature of at least 90° C., and preferably between 90° C. and 200° C.

A third aspect of the present invention provides, a catalytic zinc oxide, preferably a zinc oxide powder, comprising zinc oxide particles having:
a surface area from 0.1 to 6 m²/g; and
a porosity of less than 3%.

In this aspect of the invention, an improved catalytic ZnO powder is provided having a controlled surface area and surface activity. Unlike conventional zinc oxide, the Applicant has surprisingly found that a high surface area of the catalytic zinc oxide is not the most important factor in catalytic behavior of zinc oxide, particularly for rubber vulcanization. The Applicant has found that the heat treatment method of the first and second aspect of the present invention provide an improved catalytic ZnO, having a low surface area compared to conventional French process ZnO, and a lower porosity. Again, these and other relevant properties can be optimised for applications such as rubber vulcanization where these properties are critical.

As discussed in relation to the method and process aspects of the present invention, the surface area and porosity can be selectively controlled by roasting temperature selection. In preferred embodiments, the surface area is controlled to be less than 5 m²/g, and more preferably to be from 0.2 to 3 m²/g. Similarly, the porosity is preferably controlled to be less than 2%, and more preferably between 0.1% and 2%.

The particle size can be important in certain catalytic applications. In some application, it can be preferable for 90% of the particles have a particle size of between 0.2 μm and 50 μm, preferably between 1 μm and 20 μm. In some embodiments, 90% of the particle have a particle size of between 1 μm and 50 μm, and more preferably between 5 μm and 45 μm.

The presence of chloride is unique to Metsol Zinc Oxide due to the use of a chloride lixiviant (NH₄Cl). The chloride level is dependent on the calcination temperature. The chloride level can range from <0.10 to 16%, and preferably 0.0001 to 1%, and more preferably 0.0001 to 0.6%.

The present invention also provides in a fourth aspect, a catalytic zinc oxide according to the third aspect of the present invention produced by a method or process according to the first aspect or second aspect of the present invention.

### BRIEF DESCRIPTION OF THE DRAWINGS

The present invention will now be described with reference to the figures of the accompanying drawings, which illustrate particular preferred embodiments of the present invention, wherein:

FIG. 1 provides a basic process flow diagram of a first process of producing catalytic zinc oxide according to the present invention.

FIG. 2 provides a basic process flow diagram of a second process of producing catalytic zinc oxide according to the present invention.

FIG. 3 provides SEM images of a powdered (non-heat treated) ZnO particles produced from the Metsol process.

FIG. 4 provides SEM images of a powdered ZnO particles produced from the Metsol process heat treated to 850° C.

FIG. 5 provides SEM images of a powdered ZnO particles produced from the French Process heat treated to 220° C.

FIG. 6 provides SEM images of a powdered ZnO particles produced from the French Process heat treated to 850° C.

FIG. 7 is plot showing the effect of calcination temperature of ZnO particles on the surface area of the product.

FIG. 8 is a plot of pore volume distribution for Heat Treated Metsol ZnO as a function of particle size.

FIGS. 9A and 9B show plots of porosity vs pore size for various zinc oxide samples subject to varying heat treatment temperatures.

FIG. 10 is a plot of chloride level in Metsol ZnO versus heat treatment temperature.

FIG. 11 is a comparative plot of rubber vulcanization completion (measured as Torque) over time for (A) Metsol ZnO heat treated to 850° C.; (B) Untreated Metsol ZnO; (C) Water treated and dried Metsol ZnO and (D) a control French Process sample.

FIG. 12 is a comparative plot of the relative reactivity of the calcined samples (calculated using the reciprocal of the time for 50% curing of rubber divided by the measured surface area) against the calcination temperature.

FIG. 13 is a comparative plot of the relative reactivity of the calcined samples (calculated using the reciprocal of the time for 50% curing of rubber divided by the measured surface area) against the surface area of the individual sample.

### DETAILED DESCRIPTION

The Applicant has discovered that an improved catalytic ZnO powder having a controlled surface area and surface activity can be produced by thermally treating ZnO at temperatures of at least 450° C., preferably at least 500° C. and more preferably at least 600° C. This thermal treatment produces ZnO having a reactivity controlled by the nature of the surface, particle porosity as well as the particle size. This enables us to prepare a product where high reactivity can be obtained with lower surface area material than is typically the case.

The catalytic zinc oxide powder produced by the present invention has different characteristics to conventional French process produced catalytic zinc oxide. The Applicant has surprisingly found that high surface area of the catalytic zinc oxide is not the most important factor in catalytic behavior of zinc oxide, particularly for rubber vulcanization. The Applicant has found that the heat treatment method of the first and second aspect of the present invention provide an improved catalytic ZnO, having a low surface area compared to conventional French process ZnO, and a lower porosity. A catalytic zinc oxide powder produced by the process of the present invention therefore typically comprises zinc oxide particles having a surface area from 0.1 to 6 m²/g; and a porosity of less than 3%, preferably a porosity from 0.1% to 2%. Furthermore, 90% of the particles preferably have a particle size of between 0.2 μm and 50 μm. These and other relevant properties can be optimised for applications such as rubber vulcanization where these properties are critical.

Without wishing to being bound by any one theory, it is considered that part of this change in reactivity or catalytic behaviour relates to the changing nature of the porosity within the particles with heat treating. Prior to heat treatment much of the pore volume is in finer pores which then gives high surface area associated with these pores. After heat treatment the pore sizes change such that the volume in the coarser pore sizes increases whereas there is a large decrease in the volume, and hence number, of fine pores.

For catalytic reactivity, the inventors consider it likely that the most important surface area is that present on the particle surfaces and/or within coarser pores as it is unlikely that the liquid present within the vulcanization mix can penetrate the very fine pores and therefore the surface area within them plays little part within the reaction.

Furthermore, the inventors consider that this higher reactivity, particularly French Process produced zinc oxide heat treated in accordance with the process of the present invention, may also result from the calcined material having a “cleaner” surface than uncalcined material which gives an effective higher reactive surface area for the material. It is noted that vaporisation and vapour reaction for the French process zinc oxide is typically conducted in an atmosphere where the gas contains a mixture of air and products from the use of carbonaceous fuels and/or reductants. It is speculated that the surface of the zinc oxide particles are coated with carbon and other impurities from the carbonaceous fuels and/or reductants which are removed during the roasting step or steps of the process of the present invention.

Notwithstanding the exact beneficial mechanism, it should be understood that the catalytic zinc oxide of the present invention can be produced via a number of process routes, as described below:

Production from Calcination of ZnO Powder

The catalytic zinc oxide powder of the present invention can be produced from zinc oxide powder produced from existing zinc oxide production processes, such as ZnO produced using the French Process or ZnO produced using hydrometallurgical processes such as the Metsol process is described in for example international patent application PCT/AU2011/001507 (WO2012/068620A1), the contents of which are incorporated in to this specification by this reference.

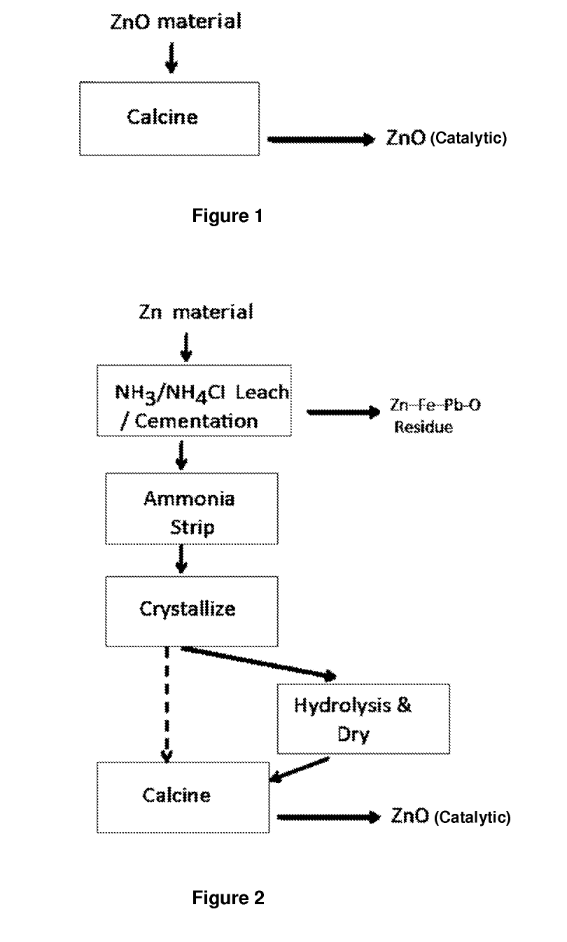

As shown in FIG. 1, the Zinc Oxide powder produced from these processes can be converted to catalytic zinc oxide by roasting or calcining that ZnO material at a temperature of greater than 450° C. in an oxygen containing atmosphere, preferably air. The roasting time is generally dependent on the quantity of ZnO being roasted, and the type and configuration of the roasting equipment. It should be understood that the roasting time can therefore vary significantly. In some embodiments, the roasting time can therefore vary between 0.1 hour to 6 hours or more.

In order to optimise the catalytic properties of the zinc oxide, the zinc oxide material is preferably roasted between 600° C. and 900° C., and more particular greater than 800° C. for 2 or more hours to produce the desired morphology, surface area and porosity properties of the resultant catalytic zinc oxide powder.

In some embodiments, the roasting step comprises a direct roast, in which the zinc oxide powder is directly roasted in a single step at the desired roasting temperature. In other embodiments, the roasting step can include two or more roasting stages.

For example, in one embodiment, the roasting step includes a first roasting stage in which the zinc oxide powder is roasted to a temperature of between 200° C. and 500° C., for example 250° C. This first roasting stage can be used to remove any moisture, for example water trapped in pores, and some impurities and surface contaminants. The morphology and catalytic properties of the zinc oxide are not markedly affected by this roasting temperature. A second roasting stage is then undertaken in which the zinc oxide powder is roasted to a temperature of greater than 500° C., for example to 800° C. or higher in order to convert the zinc oxide to catalytic zinc oxide in accordance with the present invention.

While not illustrated in FIG. 1, it may be advantageous to include a hydrolysis step prior to the roasting step, again for a cleaning and impurity removal purpose. In the hydrolysis step, the zinc oxide powder is washed or otherwise immersed in a hydrolysis solution comprising at least one of water, dilute ammonia solution. The hydrolysis solution is typically heated to a temperature of between 90° C. and 200° C.

Production from ZnO Precursors

The catalytic zinc oxide powder of the present invention can also be produced from zinc oxide precursors, and in particular crystalline zinc oxide precursors such as zinc hydroxy chloride (Zn₅(OH)₈Cl₂.H₂O), zinc hydroxide (Zn(OH)₂) or similar.

For direct conversion, the process follows the process steps shown in FIG. 1 where the zinc oxide precursor material is roasted or calcined at a temperature of greater than 450° C. in an oxygen containing atmosphere, preferably air. Again, the roasting time is generally dependent on the quantity of precursor being roasted, and therefore can vary between 0.1 hour to 6 hours or more.

Again, in order to optimise the catalytic properties of the zinc oxide, the zinc oxide precursor is preferably roasted between 600° C. and 900° C., and more particular greater than 800° C. for one or more hours to produce the desired morphology, surface area and porosity properties of the resultant catalytic zinc oxide powder.

The roasting step may also comprise a direct roast, in which the zinc oxide powder is directly roasted in a single step at the desired roasting temperature. In other embodiments, the roasting step can include two or more roasting stages. For example, in one embodiment, the roasting step includes wherein the roasting stages includes a first roasting stage in which the zinc oxide precursor is roasted to a temperature of between 200° C. and 500° C., for example 250° C. A second roasting stage is then undertaken in which the zinc oxide precursor is roasted to a temperature of greater than 500° C., for example to 800° C. or higher in order to achieve conversion of the zinc oxide precursor to catalytic zinc oxide in accordance with the present invention.

While not illustrated in FIG. 1, it may be advantageous to include a hydrolysis step prior to the roasting step, for a cleaning and impurity removal purpose. In the hydrolysis step, the zinc oxide precursor is washed or otherwise immersed in a hydrolysis solution comprising at least one of water, dilute ammonia solution. The hydrolysis solution is typically heated to a temperature of between 90° C. and 200° C.

Where significant quantities of catalytic zinc oxide is required, the conventional zinc oxide production process can be modified to include a suitable roasting or calcination step to convert the zinc oxide precursors produced in that process into a catalytic zinc oxide according to the present invention.

In one embodiment, the Metsol process of producing zinc or zinc oxide can be modified to produce catalytic zinc oxide according to the present invention.

It is to be understood that the Metsol process is a hydrometallurgical process of recovering zinc and/or zinc oxide from a zinc containing material, such as electric arc furnace (EAF) dust or a zinc containing ore selected from a zinc sulphide ore or a calcined zinc carbonate ore. In the process, the zinc containing material is leached using a lixiviant comprising an aqueous mixture of NH₃ and NH₄Cl, or ionic equivalent, having a NH₄Cl concentration between 10 and 150 g/L H2O and a NH₃ concentration of between 20 g/L H₂O and 250 g/L H₂O. The resulting zinc containing leachate is stripped of ammonia to produce a stripped liquor which includes a zinc containing precipitate. The zinc is recovered as a crystalline precipitate, typically in the form of zinc hydroxy chloride and/or zinc hydroxide. This crystalline precipitate is then subjected to a further extraction process, such as high temperature roasting, hydrolysis, a combination of hydrolysis or high temperature roasting or another process to extract the zinc content. The general Metsol process is described in for example international patent application PCT/AU2011/001507 (published as international patent publication WO2012/068620, the contents of which are incorporated into this specification by this reference) and Australian provisional patent application AU2012900554.

For the present invention, the zinc extraction step of this process from the crystalline precipitate is modified to include a specific roast or calcination step to produce the desired morphology, surface area and porosity properties of the zinc oxide powder.

A general process flow diagram for one example of a modified Metsol process is shown in FIG. 2. Following this process, the zinc containing material, (unprocessed or obtained from a suitable pre-treatment process, such as comminuting, roasting, concentration or other) is leached with an alkaline lixiviant comprising an aqueous mixture of ammonium chloride and ammonia to selectively leach out the zinc and leave the undesired impurities such as iron and lead in a sulphate free residue. The leach is preferably conducted as a two stage counter current leach. The details of this leach are covered in detail in International patent application PCT/AU2011/001507 (WO2012/068620). The lixiviant composition is preferably ˜50 g/L NH₄Cl liquor containing ˜50 g/L NH₃.

The Applicant has found that the intermediate precipitate formed during the ammonia stripping step is substantially dependant on the composition of the lixiviant used in the leaching step. The particular lixiviant formulation used in the leaching step of the present invention comprises an ammonia concentration of between 20 g/L H₂O and 150 g/L H₂O and a low NH₄Cl concentration (less than 150 g/kg H₂O, preferably less than 130 g/kg H₂O and more preferably less than 100 g/kg H₂O) leads to zinc hydroxy chloride (Zn₅(OH)₈Cl₂.H₂O), and zinc hydroxide (Zn(OH)₂) being predominantly precipitated when a selected ammonia content of the resulting leachate is stripped from solution. It should be appreciated that an amount of zinc oxide (ZnO) can also be produced.

The two stage leach system is considered to provide a zinc extraction in the order of 80 to 85%. However, it should be appreciated that the exact extraction is dependent on the composition and mineralogy of the zinc containing material used in the process. A zinc yield across leaching is typically in the order of 15 to 50 g/L based on the solubility range as the ammonia is removed and the zinc compounds precipitated. Each leaching stage is agitated, typically conducted in a stirred vessel. The Applicant has found that these particular leaching conditions are not substantially temperature dependent. Each leach stage can therefore be conducted at room temperature (10 to 35° C.) if desired. In practice, the leaching stage is run at between 30 to 90° C., and preferably at about 60° C. for circuit heat balance considerations.

The leaching step produces a pregnant liquor substantially which includes the zinc with small amounts of solubilised manganese, lead, copper and cadmium. A solid leach reside is also produced.

The pregnant liquor is then separated from the leached residue in a filter and/or thickener system to produce a high zinc content pregnant liquor. The clarity of the pregnant liquor is important in minimizing the loads on subsequent filtering stages, for example a filter after cementation (discussed below). Flocculent additions may therefore be needed to remove any fine particles in the leachate. The residue containing the lead, iron and other impurities is separated using filtration or other separation method and then pyrometallurgically or hydrometallurgically treated.

The resulting pregnant liquor typically undergoes purification processes to remove other solubilised metals. In the purification process, the pregnant liquor may be passed through a controlled oxidation step to remove the lead and manganese from the liquor, or may be fed directly to a cementation step where the copper and cadmium are removed by cementation on zinc. In the cementation process, the pregnant liquor is mixed with zinc powder typically (0.2 to 2 g/L) to remove soluble metals, especially copper, which is detrimental to the product in the ceramics market. After cementation the slurry is filtered on a fine pressure filter to remove the unreacted zinc, the metallic impurities, and colloidal particles which remain from the leach circuit.

The resultant liquor now predominantly includes the zinc in solution. The solubility of the zinc in solution is dependent on the amount of ammonia present in the liquor. The ammonia concentration can therefore be reduced to force the zinc containing crystals to precipitate. This is achieved in the present process in the strip step (FIG. 2) where an ammonia content of the pregnant liquor is stripped using heat and/or air and/or vacuum.

In one process route, the zinc rich pregnant liquor is passed into a hot ammonia stripping step. In this step, a heating system is used to pressurize and heat (typically between 80° C. and 130° C.) the pregnant liquor, which is then fed into a strip vessel (not illustrated). In some process routes, the zinc rich pregnant liquor is fed into a two step air stripping system which is discussed in detail in International patent application PCT/AU2011/001507 (WO2012/068620). In another embodiment, the heated pregnant liquor can be fed into a flash vessel (not illustrated) to flash off a mixed ammonia-water vapour stream leaving a supersaturated zinc liquor.

The stripped liquor is stripped of ammonia to a final NH₃ concentration of between 7 and 30 g/L H₂O and preferably has a pH greater than 7. The resulting stripped liquor pH and NH₃ concentration create the appropriate equilibrium conditions within that liquor to precipitate desirable basic zinc compound or mixture of compounds.

Following the process steps in FIG. 2, the supersaturated zinc liquor is passed into a crystallisation (crystallize) stage. In some embodiments, the crystallisation stage may be conducted in situ within the stripping vessels. In other embodiments, the supersaturated zinc liquor may be fed into a separate crystallisation vessel or vessels for example an agitated tank in which the liquor has an extended residence to allow the crystals to form and grow. If desired, the liquor can be cooled using a heat exchanger before entering the crystallisation tank and additional cooling can be provided in the tank. The resulting crystals are filtered on a conventional filter press, washed in a water or water-ammonia stream (produced from the stripping stage), and then discharged onto a belt conveyer.

The stripped crystals are typically predominantly zinc hydroxy chloride (Zn₅(OH)₈Cl₂.H₂O), and zinc hydroxide (Zn(OH)₂) with, in some cases, an amount of zinc oxide (ZnO). The crystals typically have ˜1 to 14% Cl with little or no ZDC content. The spent liquor from the filter press is substantially recycled to the second stage of the two stage leach. In this recycling step, the spent liquor can be used as a medium capture in the scrubber which follows the stripping column. The spent liquor may also be used as a scrubbing medium following hot air stripping column from the bleed step described below. The wash water from the crystal filter can also be used in a subsequent process, in this case a ZnCl₂ capture medium to capture ZnCl₂ volatilised during the roasting stage. It can also be used as make up water for the process.

The stripped crystals are then fed to a recovery process which can proceed along various different process steps to convert the crystals into a low chloride zinc oxide product. As shown by the solid and dashed process lines in FIG. 2, the recovery process which may include a hydrolysis stage followed by a calcining stage or a direct calcining stage. The exact converting step(s) depends on the quality and purity of zinc oxide product desired.

In some process embodiments, the stripped crystals can be hydrolysed to substantially convert any of the zinc hydroxy chloride content to at least one of zinc hydroxide or zinc oxide by washing or otherwise immersing the crystals in a hydrolysis solution. The hydrolysis solution comprises water or a dilute ammonia solution, (typically 3 to 15 g/L ammonia), and is typically heated to temperatures above 90° C. and preferably between 90 to 200° C. The hot temperature of the hydrolysis solution produces a hydrolysis product substantially comprising Zn(OH)₂ and/or ZnO zinc oxide with only a small amount of residual insoluble chloride remaining. In some cases, the hydrolysis product can include less than 0.4% insoluble chloride. This conversion route applies to crystals that are almost all zinc hydroxy chloride (˜13% Cl) through to lower chloride crystals (<7%) and very low chloride crystals (<2%) that can be made directly from the previously described ammonia strip and crystallisation steps in controlled conditions.

The reaction is not reversible and once formed the low chloride crystals do not increase in chloride content when they are cooled down, even in the presence of chloride containing liquor. The mixture can then be cooled and filtered at around 50 to 60° C. in conventional filtration equipment. Quite high solids loadings (at least 20%) can be used and therefore the water additions are quite modest.

The chloride released into the water during hydrolysis is removed using reverse osmosis to recover clean water for reuse. The chloride content is concentrated to chloride levels that are compatible with the liquor in the leaching and crystallisation stages allowing this stream to also be readily recycled in the process.

The hydrolysis product or the stripped crystals (where hydrolysis is not undertaken) can be roasted in a single stage or multiple stages to produce the catalytic zinc oxide. Low ammonia zinc containing precipitate is well suited to roasting as the main chloride containing compound zinc hydroxy chloride (Zn₅(OH)₈Cl₂.H₂O) decomposes to a mixture of ZnO (the major fraction) and ZnCl₂ (the minor fraction). The ZnO remains as a solid while the ZnCl₂ volatilises off at elevated temperatures.

In one embodiment, the crystals are heated in a first roasting step to a temperature of between 300 to 500° C. This roasting step decomposes the chloride compounds into ZnO and ZnCl₂. The soluble chloride compounds (mainly ZnCl₂) are then substantially removed in the aqueous leach to produce a leached solid. A further higher temperature calcining step, is then undertaken between 500 to 900° C. to remove any traces of chloride left and converts the Zn containing compounds in the leached solids to ZnO. The double calcining stage enables less water to be used to remove the chloride content in comparison to the previous recovery option as ZnCl₂ is extremely soluble.

In another process embodiment, the crystals are directly calcined in a furnace at a temperature of between 600 to 900° C. Any volatilised ZnCl₂ is captured and recycled. Roasting between these temperatures substantially converts the product to zinc oxide. Furthermore, any chloride content of the zinc containing precipitate is volatised at this temperature to predominantly ZnCl₂, thereby giving a low chloride high purity product. Some traces of HCl may also be given off early in the roast through part reaction of the ZnCl₂ and H₂O vapour.

While higher temperatures speed up the volatilization, the final roasting temperature depends mainly on the economics at any specific installation. Firstly, higher temperatures, of greater than 800° C. produce more desired morphology, surface area and porosity properties for catalytic zinc oxide powder. Furthermore, removal of chlorides to <0.4% Cl in the end product typically involves roasting the zinc containing precipitate to temperatures in the order of 500 to 800° C., and removal of chlorides to <0.2% Cl in the end product typically involves roasting the zinc containing precipitate to temperatures in the order of 600 to 800° C. even with prior treatment.

In each of the roasting embodiments, a substantially pure catalytic zinc oxide product is produced.

### EXAMPLES

The present invention will now be described with reference to the following examples which illustrate particular preferred embodiments of the present invention in which range of catalytic zinc oxide powers according to the present invention were produced for testing and analysis.

### Sample Sources

Zinc oxide samples for thermal treatment were sourced from two separate zinc oxide production processes:

Firstly, Metsol process produced zinc oxide (the Metsol samples) obtained using a Metsol process pilot plant, in Adelaide, Australia which produces zinc oxide using the Metsol process as described above and described in International patent application PCT/AU2011/001507 (WO2012/068620) in the name of the same Applicant.

The Metsol samples were prepared from Electric Arc Furnace (EAF) dust feed stock which was batch leached in a two stage leach system, as described above, with a leach solution of ˜50 g/L NH₄Cl liquor containing ˜50 g/L NH₃ at about 60° C. The precipitate was then stripped of ammonia using a two stage hot ammonia stripping step and allowed to crystallize into crystals comprising zinc hydroxy chloride or a mixture of zinc hydroxide and zinc hydroxy chloride.

The crystals were hydrolysed at 100° C. in dilute ammonia for >2 hours to produce a mixture of zinc oxide/ hydroxide containing minimal insoluble chloride impurity (<0.6%).

Three batches of samples were produced:

(A) Metsol Samples 1—in which the hydrolysed solid was roasted in small batches (100 to 150 g) in a laboratory muffle furnace for >6 hours at 220° C.
(B) Metsol Samples 2—in which batches of the 220° C. roasted solid were subsequent roasted at temperatures of (i) 450° C., (ii) 600° C. and (iii) 850° C.
(C) Metsol Sample 3—in which the precipitated zinc hydroxy chloride (Zn₅(OH)₈Cl₂.H₂O) crystals were directly roasted in small batches (100 to 150 g) in a laboratory muffle furnace for >6 hours at 850° C. (i.e. no hydrolysis).

Each of the roasting steps was conducted in a substantially clean air atmosphere.

Secondly, conventionally produced French process Zinc Oxide powder (the French Process samples) was commercially obtained. As should be understood, French process zinc oxide is prepared using a conventional French zinc oxide production process in which zinc metal is vaporised and that Zn vapour is reacted with oxygen to give very fine ZnO particulates.

Two batches of samples were produced:

(A) French Sample 1—in which the obtained French Process Solid was roasted in small batches (100 to 150 g) in a laboratory muffle furnace for >6 hours at 220° C.
(B) French Process Sample 2—in which the obtained French Process Zinc Oxide was roasted at temperatures of (i) 450° C., (ii) 600° C. and (iii) 850° C.

Again, each of the roasting steps was conducted in an air atmosphere.

Various properties of the samples were then measured.

### Crystal Morphology

An SEM investigation was conducted to compare the crystal morphology of:

(i) Metsol Sample 1 (220° C. drying);
(ii) Metsol Sample 2(iii) (850° C. roasted);
(iii) French Sample 1 (220° C. roasted); and
(iv) French Sample 2(iii) (850° C. roasted).

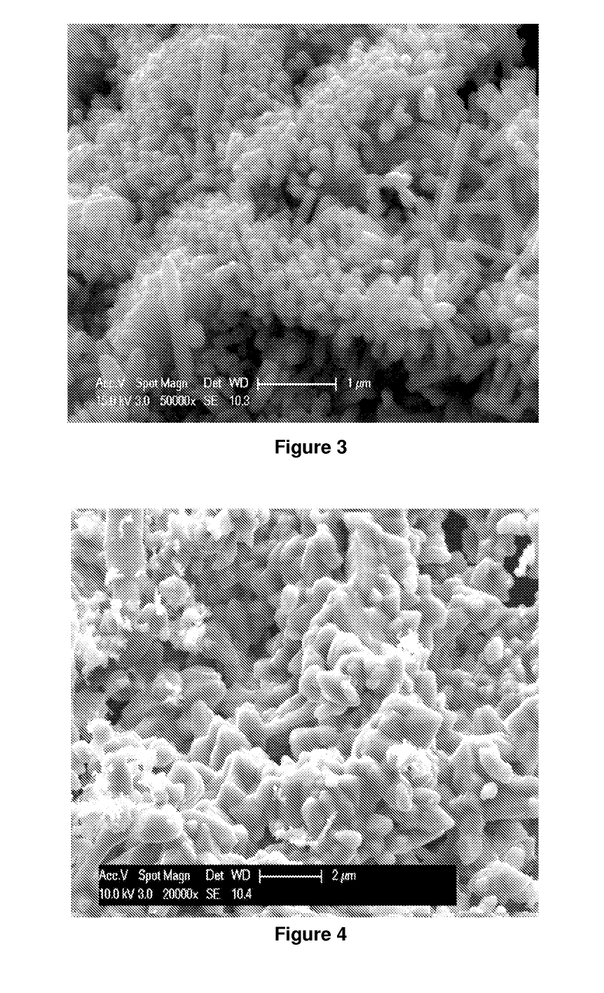

SEM images taken during this investigation are provided in FIGS. 3 to 6.

Firstly, comparing the crystal structures of the Metsol samples shown in FIG. 3 (hydrolysed+220° C. dried solid) and FIG. 4 (hydrolysed+850° C. roasted), it can be seen that the changes in crystal structure are marked. The 220° C. crystals shown in FIG. 3 have a rod like structure collected in clusters, forming a stacked packed network of rods. This structure would form a large network of passageways and pores in the stack, providing a large amount of fine porosity. After heat treatment, the structure of the individual particles becomes increasingly crystalline, with the individual rods appearing to have agglomerated and melded together into larger bodies. This structure would likely have much less fine porosity.

[symbol]

French Process and Metsol Process samples with roasting/calcination temperature.

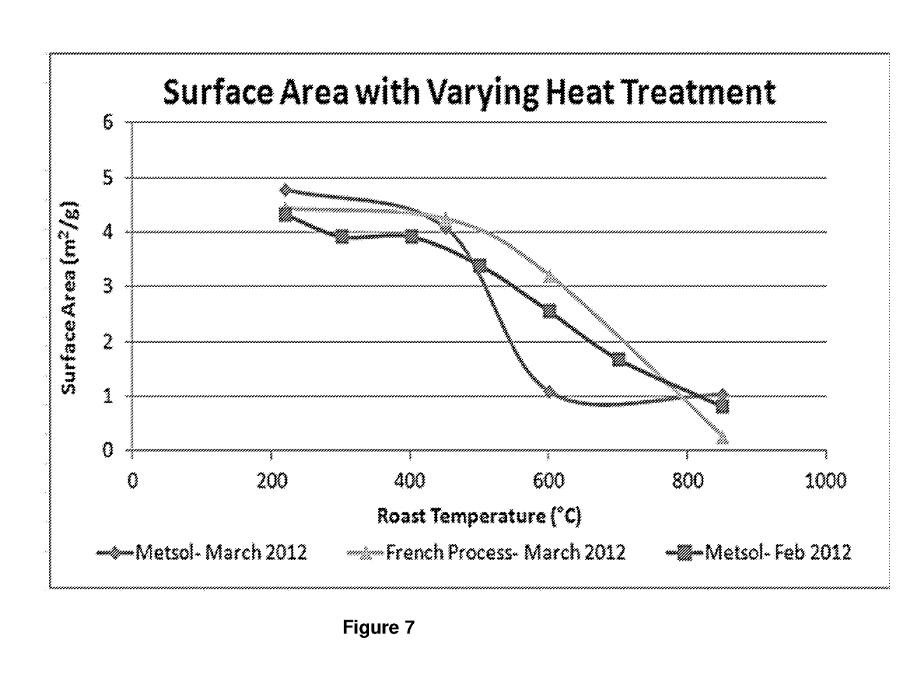

The amount the surface area decrease is very dependent on the heat treatment temperature as shown in FIG. 7. The surface area of the product can therefore be controlled by calcining at selected temperatures. This enables products of controlled surface areas to be prepared through a simple heat treatment process.

The mechanism for this change in surface area can differ dependent on the origin of the ZnO being treated.

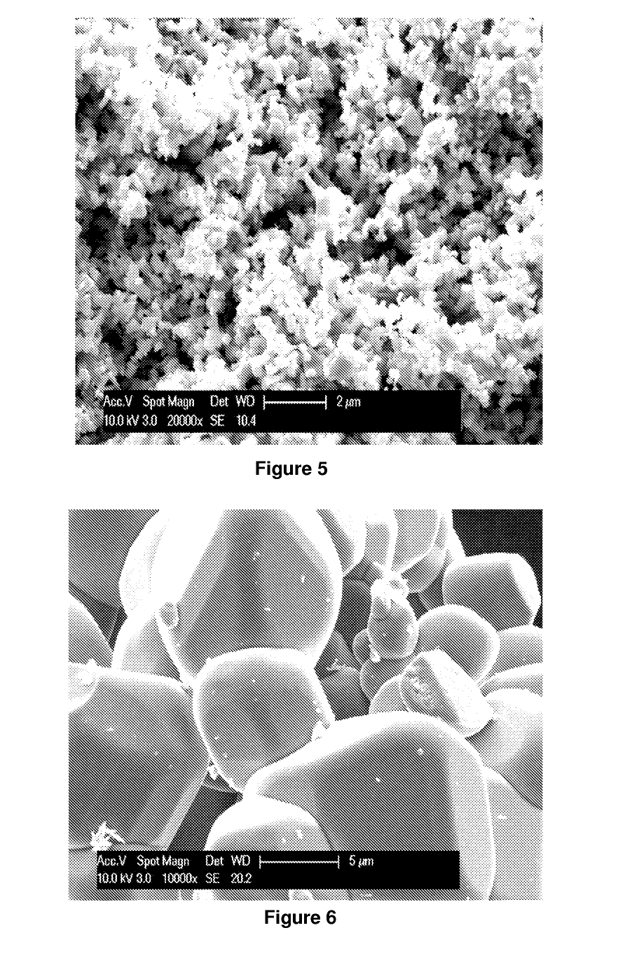

For French Process ZnO it appears that after calcination there is a much greater amount of coarser material in the product indicating sintering. The SEM images shown in FIGS. 5 and 6 clearly show growth in particles which are much more crystalline and this coarser less crystalline property is also shown in the size and bulk density measurements given in Table 1.

For Metsol Process (hydrometallurgical) ZnO, the surface area appears to be more linked to a change in the structure of the individual particles with the particles becoming increasingly crystalline with much less fine porosity present as shown in the SEM images shown in FIGS. 3 and 4. For this material much of the surface area present in the uncalcined material is thought to come from the presence of fine pores within the particles as the surface area is much higher than would be expected based solely on the surface area of the individual particles which are noticeably coarser than those found in the French Process ZnO with the same surface area.

### Porosity

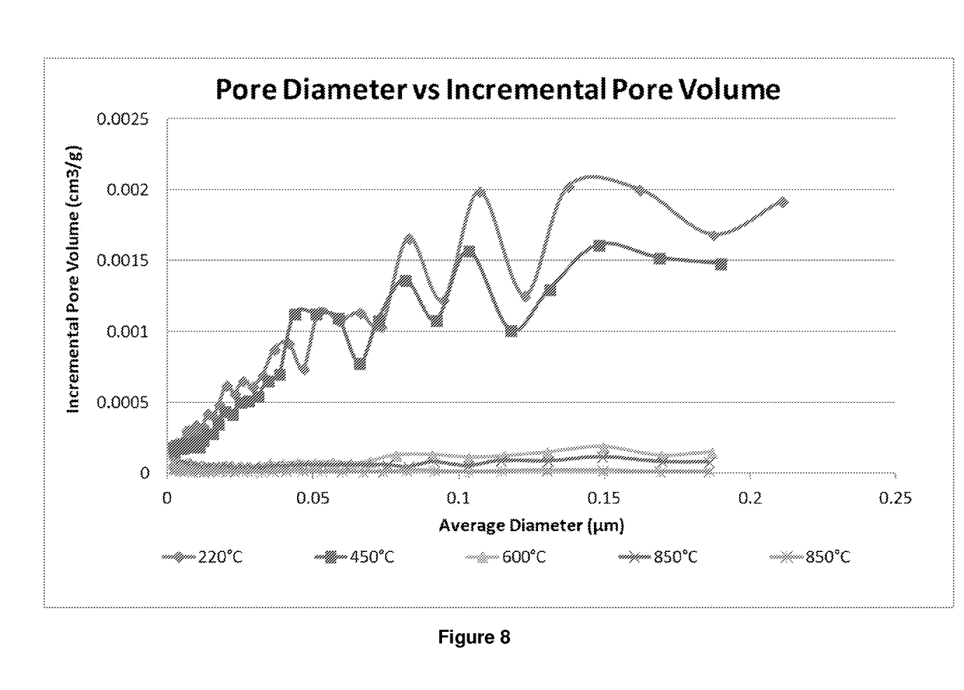

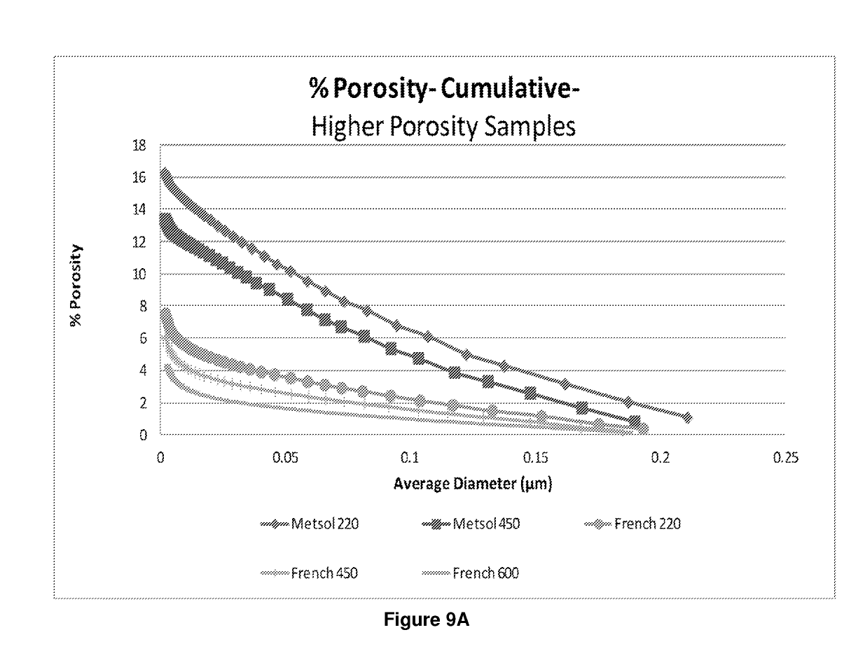

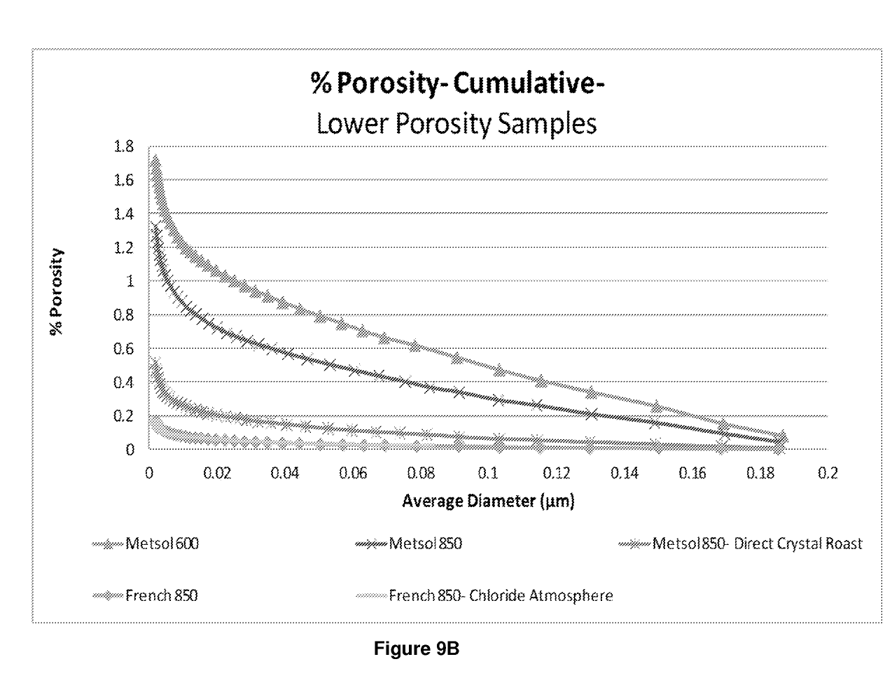

Porosity measurements of the various heat treated Metsol Process Samples is provided in FIGS. 8, 9A and 9B. The porosity traces shown in FIGS. 8, 9A and 9B confirm the surface area measurements and SEM image results, highlighting that much of the surface area present in the 220° C. treated Metsol process ZnO material is contained in very small pores. It is speculated that these fine pores may be too fine to allow enough liquid movement in and

[symbol]

[symbol]

(hydrolysed) and dried to give a fine powder which has a surface area from 2 to 4 m^{2/}g and a bulk density of around 0.87 to 1.14 g/ml. The particles largely retain the same size and shape during this reaction with hot water unless the hydrolysed product is wet milled such as described above. This powder is suitable in this form for many applications such as in agricultural and ceramic uses and can be sold without further treatment.

The heat treatment at a range of temperatures in accordance with the present invention of even this lower surface area coarser material gives a ZnO product that can be used for rubber vulcanization.

### Chlorine Removal

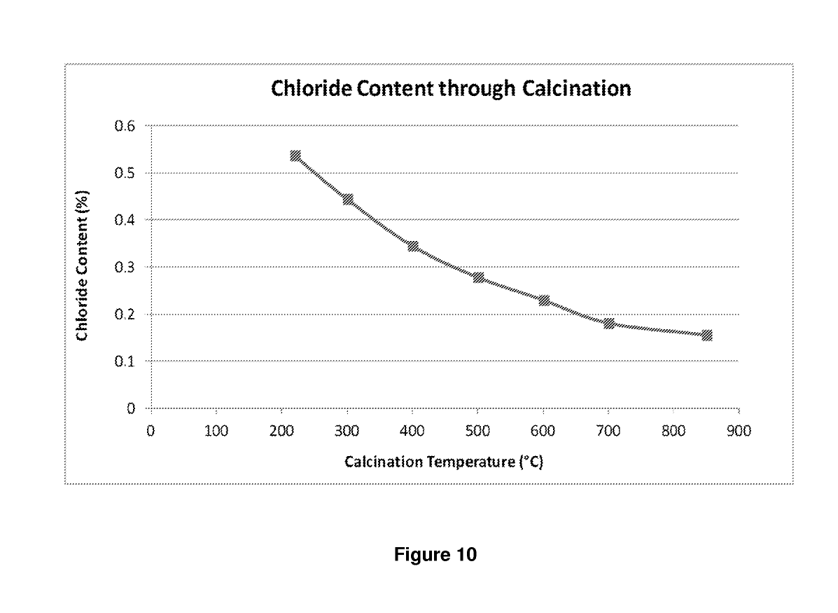

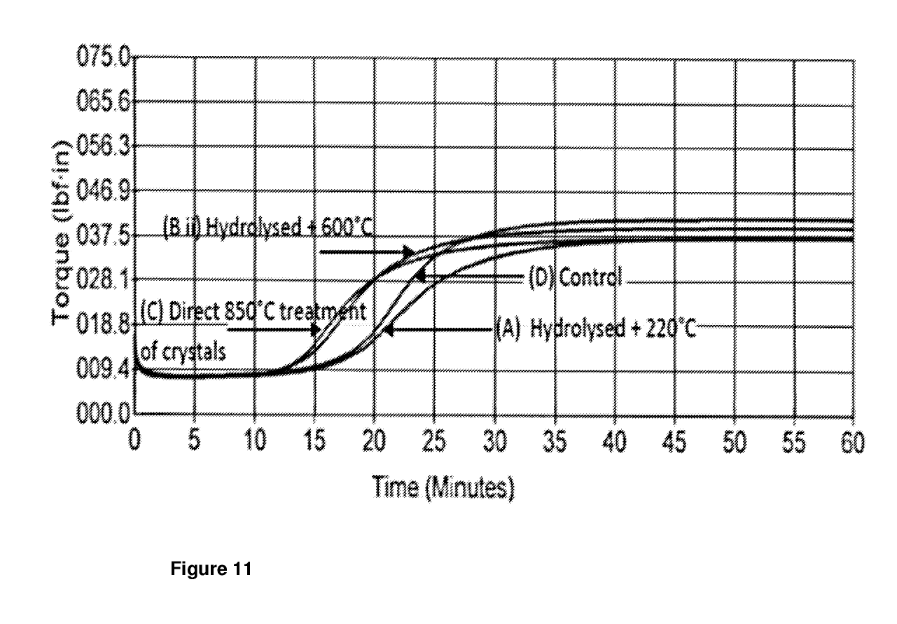

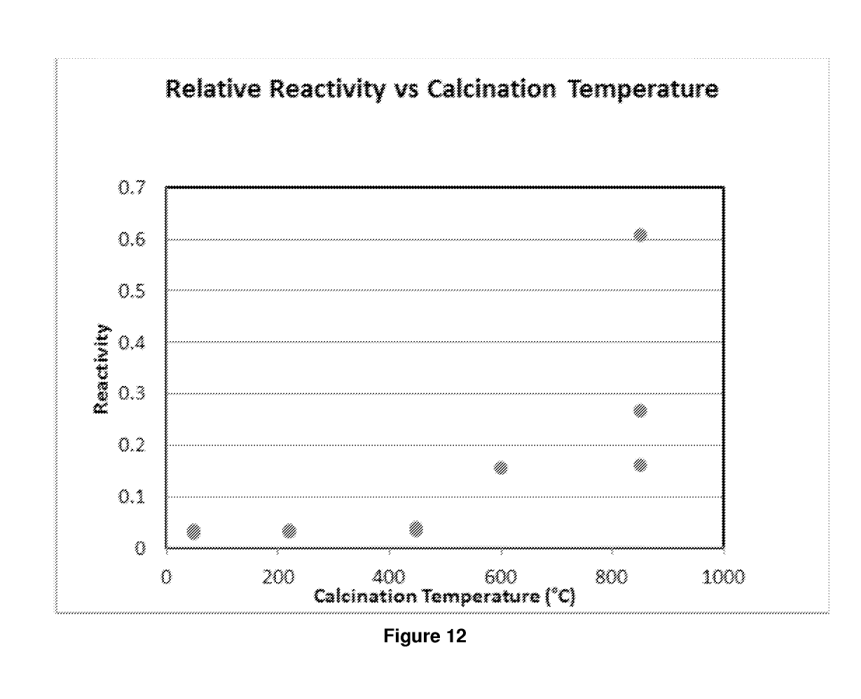

The chloride level in the product also changes with heat treatment as shown in FIG. 10 for the Metsol samples.

The calcination of the Metsol (hydrometallurgical) samples has an added advantage of removing any traces of residual insoluble chloride from the product to give a slightly higher purity. The Applicant speculates that this content would likely have very little impact on the reactivity in vulcanization where the driver is the zinc content and the change in zinc content across calcination is <0.5% but may improve the commercial acceptability of the product into a conservative industry.

### Vulcanizing Reactivity

The calcined materials have been tested for reactivity in vulcanizing rubber which is the major commercial use of ZnO. The tests have shown that unexpectedly the low surface area calcined material has higher reactivity than the conventional uncalcined French Process ZnO or the higher surface area more porous ZnO from hydrometallurgical production.

Vulcanisation tests have been carried out using the various heat treated Metsol ZnO samples and the heat Treated French Process ZnO samples to investigate whether the reactivity can be altered through this heat treatment to give suitable properties for a range of applications. Table 4 summarises the

[symbol]

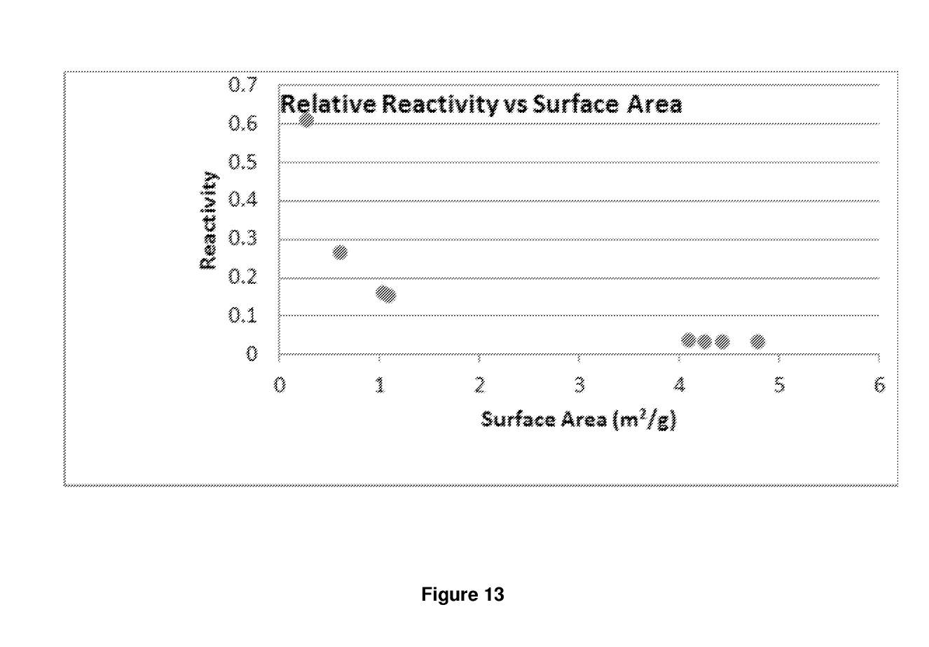

Overall, these tests confirm the higher reactivity of the heat treated ZnO despite the lower surface area (indicated by lower cure times). This result is also illustrated in FIG. 13.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A method of producing a catalytic zinc oxide, the method including the step of:
roasting a zinc oxide powder or suitable precursor thereof at a temperature of at least 450° C.,
thereby producing a catalytic zinc oxide comprising zinc oxide particles having a surface area from 0.1 to 6 mg²/g; and a porosity of less than 3%.

2. A method of producing a catalytic zinc oxide according to claim 1, wherein the roasting step is conducted in an oxygen containing atmosphere, preferably air.

3. A method of producing a catalytic zinc oxide according to claim 1, wherein the roasting step is conducted at a temperature of between 450° C. and 1000° C.

4. A method of producing a catalytic zinc oxide according to claim 1, wherein the roasting step is conducted at a temperature of at least 650° C., preferably between 600° C. and 900° C., and more preferably greater than 800° C.

5. A method of producing a catalytic zinc oxide according to claim 1, wherein the roasting step comprises at least two roasting stages.

6. A method of producing a catalytic zinc oxide according to claim 5, wherein the roasting stages include:
at least a first roasting stage in which the zinc oxide powder or precursor is roasted to a temperature of between 200° C. and 500° C.; and
at least a second roasting stage in which the zinc oxide powder or precursor is roasted to a temperature of greater than 500° C.

7. A method of producing a catalytic zinc oxide according to claim 1, wherein the zinc oxide powder or precursor is roasted in the roasting step for at least 0.1 hours, preferably at least 1 hour, and more preferably between 2 and 10 hours.

8. A method of producing a catalytic zinc oxide according to claim 1, further including the step prior to the roasting step of:
washing the zinc oxide powder or precursor in a hydrolysis solution comprising at least one of water, dilute ammonia solution.

9. A method of producing a catalytic zinc oxide according to claim 8, wherein the hydrolysis solution is heated to a temperature of at least 90° C., and preferably between 90° C. and 200° C.

10. A method of producing a catalytic zinc oxide according to claim 1, wherein the zinc oxide precursor comprises at least one of zinc hydroxide, or zinc hydroxy chloride.

11. A method of producing a catalytic zinc oxide according to claim 1, wherein the zinc oxide is produced from at least one of the French Process or the Metsol Process.

12. A process for producing catalytic zinc oxide from a zinc containing material including the steps of:
leaching the zinc containing material with an alkaline lixiviant comprising an aqueous mixture of NH₃ and NH₄Cl, or ionic equivalent, having a NH₄Cl concentration of between about 10 g/L and about 150 g/L H₂O and a NH₃ concentration of between 20 g/L H₂O and 250 g/L H₂O, to produce a zinc containing leachate and a solid residue;
stripping ammonia from the leachate to produce a stripped liquor which includes a zinc containing precipitate, the stripped liquor having a NH₃ concentration of between 7 and 30 g/L H₂O;
separating the zinc containing precipitate from the stripped liquor; and
roasting the zinc containing precipitate to a temperature of at least 450° C. to convert the zinc containing precipitate to zinc oxide,
thereby producing a catalytic zinc oxide comprising zinc oxide particles having a surface area from 0.1 to 6 m²/g; and a porosity of less than 3%.

13. (canceled)

14. (canceled)

15. (canceled)

16. (canceled)

17. (canceled)

18. (canceled)

19. (canceled)

20. (canceled)

21. (canceled)

22. (canceled)

23. A catalytic zinc oxide comprising zinc oxide particles having:
a surface area from 0.1 to 6 m²/g; and
a porosity of less than 3%.

24. A catalytic zinc oxide according to claim 23, wherein the surface area is less than 5 m²/g, preferably from 0.2 to 3 m²/g.

25. A catalytic zinc oxide according to claim 23, wherein the porosity is less than 2%, preferably from 0.1 to 2%.

26. A catalytic zinc oxide according to claim 23, wherein 90% of the particles have a particle size of between 0.2 μm and 50 μm, preferably between 1 μm and 20 μm.

27. A catalytic zinc oxide according to claim 23, wherein the zinc oxide comprises a powder.

28. (canceled)

29. A method according to claim 1, wherein the surface area of the catalytic zinc oxide is less than 5 m²/g, preferably from 0.2 to 3 m²/g.

30. A method according to claim 1, wherein the porosity of the catalytic zinc oxide is less than 2%, preferably from 0.1 to 2%.

31. A method according to claim 1, wherein 90% of the particles of the catalytic zinc oxide have a particle size of between 0.2 μm and 50 μm, preferably between 1 μm and 20 μm.
